(19) United States
(12) Patent Application Publication
(10) Pub. No.: US 2005/0013496 A1
(43) Pub. Date: Jan. 20, 2005

(54) Video decoder locally uses motion-compensated interpolation to reconstruct macro-block skipped by encoder

(76) Inventors: Wilhelmus Hendrikus Alfonsus Bruls, Eindhoven (NL); Frederik Jan Bruijn, Eindhoven (NL); Gerard De Haan, Eindhoven (NL); Dzevdet Burazerovic, Eindhoven (NL); Gerardus Johannes Maria Vervoort, Eindhoven (NL)

Correspondence Address: Corporated Patent Counsel;U.S. Philips Corporation, 580 White Plains Road, Tarrytown, NY, 10591, US

(21) Appl. No.: 10/621,003

(22) Filed: Jul. 16, 2003

(51) Int. Cl. G06K 9/36

(52) U.S. Cl. 382/239; 382/236

(57) ABSTRACT

In macroblock-based coding systems such as MPEG-1 video, MPEG-2 video and MPEG-4 visual, an encoder in the invention decides on macroblock level whether the macroblock is to be encoded or whether local motion-compensated interpolation processing at a compatible decoder can be used to reconstruct the macroblock. In the latter case, the macroblock is skipped. If the decoder detects a skipped macroblock, the decoder reconstructs the macroblock and overwrites the data conventionally generated in MPEG under the skipped macro-block condition.

### RELATED APPLICATION

This application is a continuation-in-part, filed under 37 CFR 1.53(b), of International Application ser. no. IB/02/05500 filed Dec. 16, 2002, for Fons Bruls et al, for HYBRID COMPRESSION USING TEMPORAL INTERPOLATION, and herewith incorporated by reference.

### FIELD OF THE INVENTION

The invention relates to a method, control software and an apparatus for processing video data in a data transmission system.

### BACKGROUND ART

Efficient use of bandwidth of a data transmission channel and of data storage capacity depends, among other things, on data compression. An encoder aims at encoding the original data so as to convey the information contained in the original data using as few bits as possible. A compatible decoder receiving the encoded data recreates the original data or generates data with acceptable quality loss with respect to the original data, depending on the coding scheme applied. Data compression in video typically removes temporal and spatial redundancy. Temporal redundancy is represented by relationships between data of successive video pictures. Spatial redundancy exists between data within the same picture.

Many video coding standards have emerged for video applications such as videoconferencing, DVD and digital TV. These standards enable to achieve interoperability between systems from different manufacturers. ITU-T and ISO/IEC are the two formal organizations that develop video coding standards. The ITU-T video coding standards are denoted with H.26x (e.g., H.261, H.262, H.263 and H.264). The ISO/IEC standards are denoted with MPEG-x (e.g., MPEG-1, MPEG-2 and MPEG-4).

In currently used coding schemes, data compression relies on, among other things, motion estimation prediction (MEP). MEP determines whether two pictures are interrelated based on the amount of movement between them. The pictures to be encoded are segmented into macroblocks (MBs) of, e.g., 16 by 16 pixels. Each MB is searched for the closest match in the search area of another picture that serves as a reference. Upon finding a match, the spatial offset is determined between the picture and the reference picture. This offset represents a local motion vector. Local motion vectors are then used to construct a predicted picture for comparison with the picture to be encoded. An MB that has a match has already been encoded, and is therefore redundant. Only its motion estimation vectors need to be provided. An MB that does not match with a part of the search area represents a difference between the pictures and is encoded.

MPEG-based video coding uses three types of pictures (or frames) referred to as intra-pictures (I-pictures), predicted (P-) pictures and bi-directional (B-) pictures. The MBs of I-pictures are only spatially encoded. MBs of P-pictures are both temporally and spatially encoded. The reference picture for a P-picture is the immediately preceding I- or P-picture in the video sequence. MBs in B-pictures are both temporally and spatially encoded as well. Each B-picture has two reference pictures: one that precedes the B-picture and one that follows the B-picture in presentation order. A prediction MB can selectively originate in the preceding reference picture, in the following reference picture or may be an interpolation of a prediction MB in the preceding reference picture and a prediction MB in the following reference picture. The reference picture(s) from which each prediction MB originates may be determined on an MB-by-MB basis. The reference pictures for B-pictures are the immediately preceding I- or P-picture and the immediately following I- or P-picture, in presentation order. Other more complex prediction schemes may be used.

It is not strictly necessary to encode each MB in the MPEG standard as standardized conditions are prescribed relating to the skipping of MBs. See, e.g., U.S. Pat. No. 6,192,148, incorporated herein by reference, which discusses such method for encoding video pictures using the skipping of MBs.

### SUMMARY OF THE INVENTION

The ISO and ITU video compression standards allow forward predictive and bidirectional predictive encoding, resulting in the generation the P- and B-frames, respectively. Motion-compensated predictive coding exploits the temporal correlation between consecutive frames. In practice, however, in MPEG-2 the average bitrate of predictive frames is often not more than a factor of four lower than the bit-rate of an I-frame in the same group of pictures (GOP). This factor of four is considered to be somewhat disappointing, given the visual similarity between consecutive frames and the quality offered by another motion-compensated prediction technique, which is used in picture rate conversion and known as “Natural Motion” (NM), described in, e.g., “IC for motion compensated deinterlacing, noise reduction and picture rate conversion”, G. de Haan, EEE Transactions on Consumer Electronics, Vol.45, pp.617-624, August 1999. The NM-algorithm, developed by Philips Electronics for its high-end 100 Hz televisions, removes motion judder from film-originated video material. The algorithm generates additional intermediate pictures between the ones registered on the film instead of simply repeating earlier ones. This interpolation process shows a clear similarity with the generation of B-frames in MPEG. However, NM does not require the transmission of vector data and/or residual data, in contrast with the generation of conventional B-frames. The autonomous operation of the NM-process makes it an interesting addition to a video-compression system.

In the invention, an NM-based algorithm is integrated with an MPEG-2 scheme. The NM-process is set up to generate “alternative B-frames” based on an input of MPEG I- and P-frames, both during encoding and decoding. In the encoder, each NM output frame is compared with an original B-frame. A criterion, specifically designed for this task decides whether it is necessary to locally fall back on the original B-frame content in order to prevent visible errors. In this case, the vectorial and residual data of the original B-frame data is preserved in the MPEG-stream.

The addition of a proprietary extension to the existing coding standard affects compatibility, in this case with normal MPEG-2 decoders. The integration of NM with MPEG-2 according to the invention is such that the MPEG-compliance of the stream syntax is maintained. The presented approach is also suitable for use with other ISO and ITU compression standards such as MPEG-4 and H.264.

More specifically, an embodiment of the invention relates to a method of encoding a video picture. For each segment of the video picture it is then determined if the segment can be reconstructed from at least another video picture based on motion-compensated interpolation applied to the other video picture. If the segment cannot be reconstructed, the segment is encoded, and otherwise skipped. The segment is, e.g., a macroblock. Preferably, the method of encoding uses a coding scheme compliant with one of ISO and ITU video compression standards. For example, assume that the coding scheme complies with MPEG-2. The determining step of the method comprises decoding an encoded B-picture; generating a further picture using motion-compensated interpolation applied to the other video picture; determining a difference per macroblock between the decoded B-picture and the further picture; and evaluating the difference under control of a consistency measure of motion vectors associated with the further picture. A variation on this method is to determine the difference per macroblock between the further picture and the original video picture to be encoded (instead of the decoded B-picture).

A further embodiment of the invention relates to an electronic device with an encoder for encoding a video picture. The encoder is configured to determine for a segment, e.g., a macroblock, of the picture if the segment can be reconstructed from at least another video picture based on motion-compensated interpolation applied to the other video picture. The encoder encodes the segment if the segment cannot be reconstructed, and skips the segment otherwise. Preferably, the encoder is configured to use a coding scheme compliant with one of ISO and ITU video compression standards. For example, the coding scheme complies with MPEG-2. The encoder then comprises a decoder for decoding an encoded B-picture; a generator for generating a further picture using motion-compensated interpolation applied to the other video picture; a comparator for determining a difference per macroblock between the decoded B-picture and the further picture; and an evaluator for evaluating the difference under control of a consistency measure of motion vectors associated with the further picture. A variation on the encoder is one that has a generator for generating a further picture using motion-compensated interpolation applied to the other video picture; a comparator for determining a difference per macroblock between the further picture and the (original) video picture; and an evaluator for evaluating the difference under control of a consistency measure of motion vectors associated with the further picture.

Another embodiment relates to a method of decoding an encoded video picture. The method comprises a step of determining if a segment, e.g., a macroblock, of the picture is missing. If there is a missing segment, it is reconstructed from motion-compensated interpolation applied to at least another video picture. The video picture is encoded using a coding scheme, e.g., compliant with one of ISO and ITU video compression standards. The decoding of the picture then uses an MPEG-2 skipped-macroblock condition; and writes the data, generated by the motion-compensated interpolation to reconstruct the macroblock, over further data conventionally generated under the skipped-macroblock condition.

Yet another embodiment relates to an electronic device comprising a decoder for decoding an encoded video picture. The decoder is operative to reconstruct a segment, e.g., macroblock, missing from the video picture, based on motion-compensated interpolation applied to at least another video picture.

Yet another embodiment relates to control software for installing on an electronic device for decoding a video picture from which a segment is missing. The software is configured to reconstruct the segment based on motion compensated interpolation applied to at least another video picture.

Still another embodiment relates to control software for installing on an electronic device for encoding a video picture. The software is configured to determine for a segment of the picture if the segment can be reconstructed from at least another video picture based on motion-compensated interpolation applied to the other video picture. The software then controls the encoding so as to have the segment encoded if the segment cannot be reconstructed, and to have the segment skipped otherwise.

Yet another embodiment relates to electronic video content information encoded such that at decoding at least one segment, e.g., a macroblock, of at least one picture is to be reconstructed using motion-compensated interpolation performed on at least one other picture.

The hybrid scheme of the invention leads to a bit-rate reduction by a factor of between 1.41 and 1.54 compared to conventional MPEG-2. This is regardless of the complexity of the video scene. The visual quality is considered as comparable to the original MPEG-output. The contribution of the B-frames to the total bit-rate constitutes up to 50% of the total bit-rate under conventional MPEG-2 coding scheme. In the invention, up to 90% of a B-frame is replaced by NM, so that a considerable overall bit-rate reduction is achieved.

### BRIEF DESCRIPTION OF THE DRAWING

The invention is explained in further detail, by way of example and with reference to the accompanying drawing wherein:

FIG. 1 gives mathematical expressions referred to in the text;

FIG. 2 is a block diagram of an MPEG-2 video encoder with NM interpolation;

FIG. 3 is a block diagram of a component of the encoder in FIG. 2;

FIG. 4 is a block diagram of an MPEG-2 video decoder with NM interpolation;

FIG. 5 is a flow diagram of a method of encoding in the invention;

FIG. 6 is a flow diagram of a method of decoding in the invention

Throughout the figures, same reference numerals indicate similar or corresponding features.

### DETAILED EMBODIMENTS

The inventors propose to use local motion processing in a receiver/decoder in order to reconstruct an encoded picture or parts thereof, e.g., by using information from two pictures, preferably one in the past and one in the future of the picture under consideration. The invention uses local motion processing in receivers with the purpose of improving the coding efficiency of video coding systems. The improvement of the coding efficiency is achieved by skipping the coding of an image's segment, e.g., a macroblock, if it can be reconstructed reliably with local motion processing at the receiver/decoder. In macroblock-based coding systems such as MPEG-1 video, MPEG-2 video and MPEG-4 visual, an encoder in the invention uses decides on macroblock level whether the macroblock is to be encoded or whether local motion processing at the receiver can be used to reconstruct the macroblock. In the latter case, the macroblock is not coded and is just skipped. If the decoder detects a macroblock has been skipped, the decoder determines that such macroblock is to be reconstructed by local motion processing.

The invention is based on the following insights. There are two main causes for the limited efficiency gain of predictive coding over intra-coding: the motion-estimation process and the criterion to evaluate each locally predicted picture part. In most MPEG-2 implementations, motion compensation is based on a computationally efficient derivation of full-search block matching (FSBM). The motion vectors resulting from FSBM minimize the block-wise difference between the prediction and the original. The block-wise difference is often calculated as the mean squared error (MSE) or as the mean absolute difference (MAD). In either case, the difference criterion minimizes the local residual data amount, but does not result in a true-motion estimate. Consequently, MPEG motion vectors may not necessarily describe the true object motion and tend to be temporally and spatially inconsistent. Within this context see, e.g., U.S. Pat. No. 6,567,469 (attorney docket US 000022) incorporated herein by reference and discussed below. In practice, transmission of residual (difference) data is vital for artifact-free reconstruction. In contrast with MPEG, the temporally interpolated frames produced by NM result in high-quality motion-compensated predictions without addition residual information. The interpolated frames are based on estimates of the true motion, which are generated using a three-dimensional recursive search (3DRS) block-matcher instead of a full-search block matcher. See, for example, G. de Haan cited supra, and U.S. Pat. No. 5,072,293, U.S. Pat. No. 5,148,269, and U.S. Pat. No. 5,212,548 incorporated herein by reference. The motion-vectors estimated using 3DRS exhibit a high degree of spatial and temporal consistency. The 3DRS-algorithm can be modified to minimize the block-wise difference between prediction and original. At the cost of loosing the motion vector consistency, the application of 3DRS has shown to enable a computationally more efficient MPEG-2 encoder implementation with better compression results, compared to (efficient) FSBM-variants. See, e.g., “A single-chip MPEG2 encoder for consumer video storage applications”, W. Bruls et al., ICCE Digest of Technical Papers, pp. 262-263, June 1997.

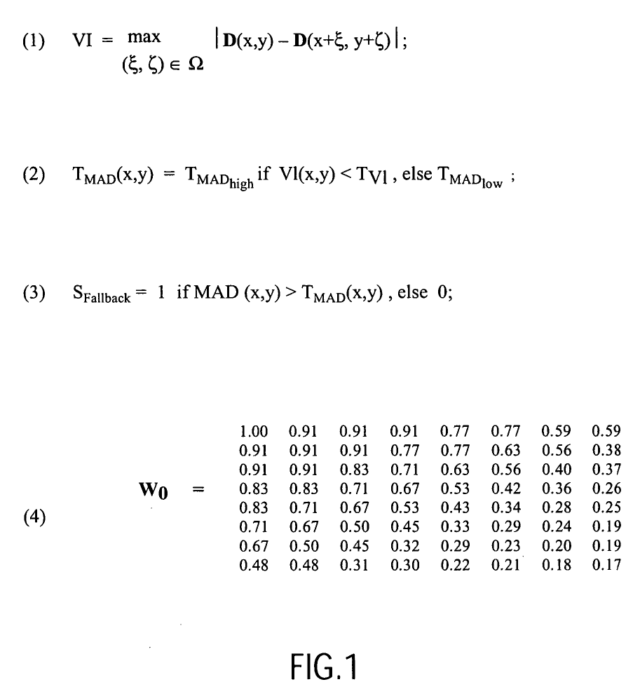

Therefore, a possible solution to improve on standard MPEG-2 or MPEG-4 would be to skip frames during encoding, followed by an up-conversion using NM after decoding. In particular, by skipping only B-frames, which are not re-used in the prediction process, error accumulation is avoided. Unfortunately, when NM is applied to interpolate frames over large temporal distances, which is the case when several B-frames are predicted from decoded I- or P-frames, visible errors may occur since 3DRS fails to track small fast moving objects correctly. To reliably regenerate “B-frame”-like pictures with NM during decoding, the occurrence of visible errors must be detected in the encoder. In practice, however, a simple pixel-wise comparison with MPEG B-frames causes an abundance of high MAD-values in almost any detailed area, even in the absence of visual errors. However, the application of 3DRS to frame rate conversion shows that small deviations from the true motion are not perceived in consistently moving areas. As an alternative, the inventors propose to include the consistency of the motion vectors in the evaluation of the MAD-values. To quantify the concept of “vector inconsistency” (VI) the inventors determine the maximum absolute component-wise difference of a vector with surrounding motion vectors, given by expression (1) in FIG. 1. D is a 2-dimensional motion vector that describes the displacement between two consecutive frames, and Ω is the spatial area of evaluation. In areas where the inconsistency as given by expression (1) is low, large local MAD-errors are ignored, and in inconsistent areas even small local MAD-errors are considered as visible. Each MAD-value is, therefore, thresholded with a value T_{MAD}(x,y) that is taken to vary with the local VI value as given by expression (2) in FIG. 1. The parameter T_{VI} in expression (2) is a threshold of dimension “pixels/second”. The inventors have empirically determined the value for T_{VI} as around 80 pixels/sec at a D1 resolution. The value of T_{MAD}_{_{low}} is such that the noise is ignored. Methods of determining the noise level in moving video are commonly available, usually as part of a noise reduction system. See, e.g., G. de Haan et al., “TV noise reduction IC”, IEEE Transactions on Consumer Electronics, vol.44, pp 143-154, February 1998. In practice, however, it is found that such algorithms fail to establish a reliable value of T_{MAD}_{_{low}}. This is due to the fact that the “noise” that remains in decoded MPEG-frames does not match the presumed Gaussian distribution. These algorithms systematically generate estimates of T_{MAD}_{_{low}} that are too low and that even indicate almost a total absence of Gaussian noise after decompression. The inventors have found that a threshold level at T_{MAD}_{_{low}}=3 for an 8-bit luminance range results in a reliable segmentation in inconsistent areas for a large variety of video materials. The threshold value in consistently moving areas, T_{MAD}_{_{high}}, must be such that seriously large match errors are not ignored. A potentially visible error is indicated by areas where the local MAD-error exceeds the local threshold, as represented by expression (3) in FIG. 1. In case S_{fallback}(x,y)=1, i.e., a visible error is detected, it is decided to fall back on the original MPEG B-frame content.

In order to integrate NM with MPEG-2 the inventors have reasoned as follows. There are several options to correct potentially visible errors at the decoder. One option could be to send correction data through a private data channel. However, MPEG-2 already offers an efficient way to describe the content and spatial location of the areas that require correction. So, instead of creating a separate stream of correction data the inventors have chosen to preserve the corresponding area in the original B-frame, in case of a fall-back decision. By taking the decision on an MB basis the MPEG-2 syntax can be exploited, which offers an efficient way to skip several MBs within a so-called slice. In case of a fall-back decision, S_{fallback}.(x; y)=1, the corresponding MB in the original B-frame is preserved. Otherwise, it is skipped prior to variable-length encoding, thus creating a compact but reversibly decodable description of the spatial areas where NM has failed. A conventional MPEG-2 decoder deals with the skipped MBs as if they were generated under the regular “skip macro-block” conditions. This means that the motion-vector data of the previously decoded MB is repeated, and the residual data is zero. Consequently, the skipped areas will look somewhat distorted. By checking for skipped macro-blocks during decoding, the MPEG-2 decoder with NM will recognize the skipped areas and overwrites the MPEG-output in these areas with the locally generated NM-output. Unfortunately, the MPEG-2 syntax imposes some restrictions to the use of skipped MBs, e.g., the first and the last MB in a slice must always be encoded. These mandatory MBs add up to the MBs that were preserved by the selection process, which may affect the coding efficiency of the system. However, even in case of a large number of preserved MBs, the bit-rate can still be significantly reduced. This is achieved by suppressing the DCT-coefficients in these MBs, i.e., by multiplying each coefficient with an attenuation factor. The resulting smaller coefficient values will map to shorter VLC-codewords. Clearly, the DC-coefficient is not involved in the attenuation process. Furthermore, by suppressing only the AC-coefficients, more or less in proportion to their order, mostly the high-frequent content in a MB is affected. This attenuation method has been shown to successfully reduce the bit-rate during MPEG-2 transcoding. See, e.g., R. K. Gunnewiek et al., “A low-complexity MPEG-2 bit-rate transcoding algorithm”, ICCCE Digest of Technical Papers, pp.316-317, June 2000. Loss of sharpness and detail is controlled such that the MPEG-MBs blend-in seamlessly with the areas generated by NM, which are generally somewhat softer than the original MPEG-content. The weighting coefficients are collected in the weighting matrix W=αW0, where α is a control parameter with a value between 0 and 1, and W0 is given by expression (4) in FIG. 1. The pattern of decreasing matrix coefficients WOᵢⱼ is piecewise-constant along the diagonals to ensure an efficient VLC-representation after zig-zag-scanning of the coefficient values.

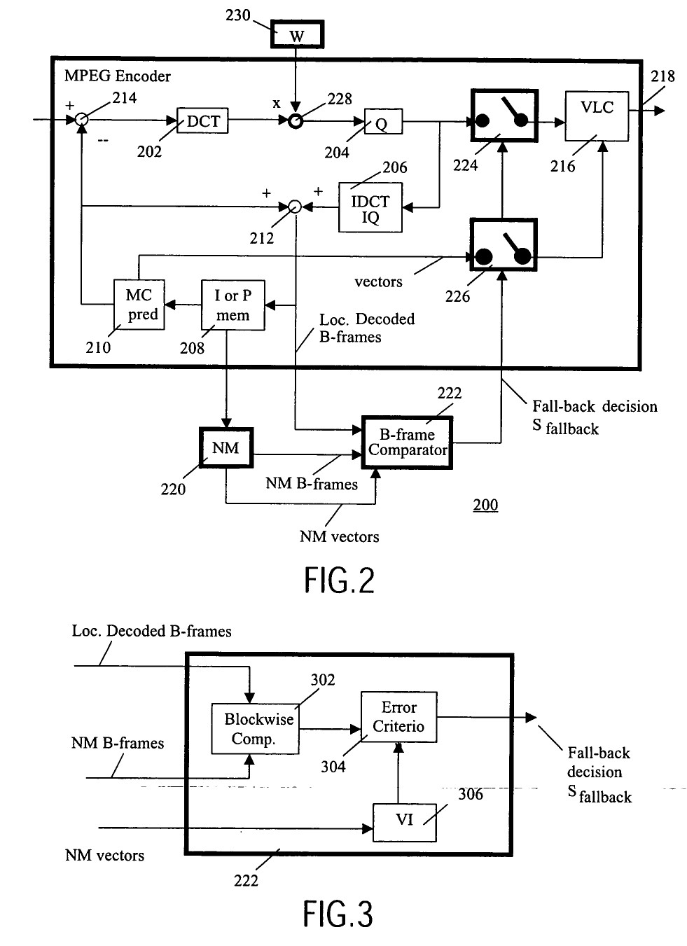

FIG. 2 is a block diagram of an interframe MPEG-2 encoder 200 combined with the NM-algorithm, as discussed above, in which the error criterion is incorporated. Instead of designing a modified MPEG-encoder, the entire process of skipping and filtering can also be realized as a transcoding process after first generating a regular MPEG-2 bitstream.

Encoder 200 comprises a Direct Cosine Transform (DCT) component 202; a quantizer 204; a component 206 to perform an inverse quantization operation and an inverse DCT operation; a memory 208 for storage of I or P frames; a motion compensation predictor 210; an adder 212; a subtractor 214 and a variable-length encoder (VLC) 216. Components 202-216 together form a conventional interframe predictive encoder wherein the difference between pixels in the current frame and their prediction values are coded and supplied as a bitstream at an output 218. For an explanation of the operation of such a conventional encoder, see any publicly available standard textbook on video coding. Encoder 200 further comprises an NM component 220 and a B-frame comparator 222. Comparator 222 is further explained with reference to FIG. 3.

The locally decoded I-frames or P-frames in memory 208 are subjected to the NM operation of NM component 220 that produces frames that are alternatives to the conventional B-frames. The creation of these alternative “B-frames”, or: NM frames, is based on the NM interpolation algorithm. These NM frames are compared to the locally decoded conventional B-frames in comparator 222. The comparison is at the MB level and uses the error criterion discussed above with reference to FIG. 1. Comparator 222 determines whether to trust the output of NM component 220 or to discard the output of component 220 and to use, instead, the MB comprising the local original B-frame data. If the output of NM component 220 can be trusted, the corresponding redundant MBs of the B-frame are skipped. To this end, comparator 222 controls switches 224 and 226. In a pass-through, or closed, position of switches 224 and 226, encoder 200 operates as a conventional interframe predictive encoder. In a blocking, or open, position of switches 224 and 226, MBs are skipped. The skipping of MBs is interpreted at a compatible decoder that they can be reconstructed using local motion-compensated interpolation. Encoder 200 further comprises a multiplier 228 for attenuating the DCT coefficients of the remaining, i.e., non-skipped, MBs using a matrix W 230 as discussed above.

FIG. 3 is a block diagram to show comparator 222 in more detail. Comparator 222 comprises a block comparator 302, a controller 304 and a vector inconsistency (VI) unit 306. Comparator 302 calculates the block-wise difference between a locally decoded B-frame and an interpolated frame (“alternative B frame”) using NM. Controller 304 controls switches 224 and 226 in response to the output of comparator 302 and of VI unit 306. VI unit 306 determines if the associated NM vectors are sufficiently consistent. Comparator 302, controller 304 and VI unit 306 are configured to implement the operations as discussed with reference to FIG. 1.

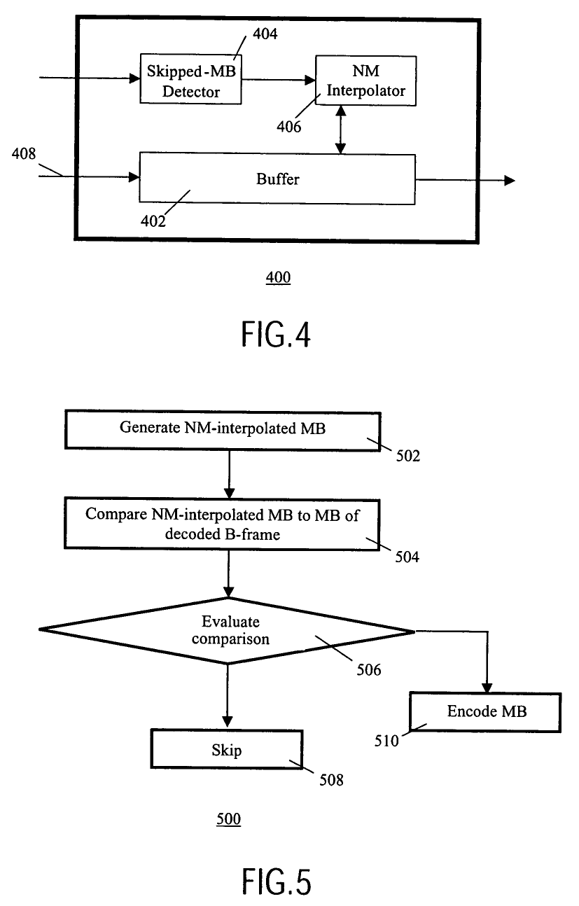

FIG. 4 is a block diagram of a part of a video decoder 400 compatible with the encoder 100 in FIG. 1. Decoder 400 comprises a buffer 402, a detector 404 and an NM interpolator 406. Buffer 402 stores decoded MBs of video frames received at an input 408. Detector 404 checks for skipped MBs. As specified above, MPEG-2 conventionally detects when an MB has been skipped (“skipped-macroblock condition”) and causes motion-vector data of a previously decoded MB to be repeated at reconstructing the skipped MB. Upon detecting a skipped MB, interpolator 406 is instructed to regenerate the data for the skipped MB using a motion-compensated interpolation algorithm, preferably identical to the one used in encoder 100. The decoded MBs of P- and/or I-frames in buffer 402 are then subjected to this algorithm. The regenerated data are written over the data that was inserted under control of the skipped-macroblock condition as conventionally applied.

FIG. 5 is a flow diagram 500 of a method of encoding in the invention. In a step 502, I-frames and/or P-frames are used to generate motion-compensated interpolated MBs. In a step 504, an NM-generated MB is compared to a spatially corresponding MB of the relevant B-frame. In a step 506, the result of the comparison is evaluated using an error criterion, e.g., the one discussed with reference to the expressions in FIG. 1. Depending on the evaluation, in a step 508 the MB is either skipped or in a step 510 the MB is coded using the conventional B-frame data.

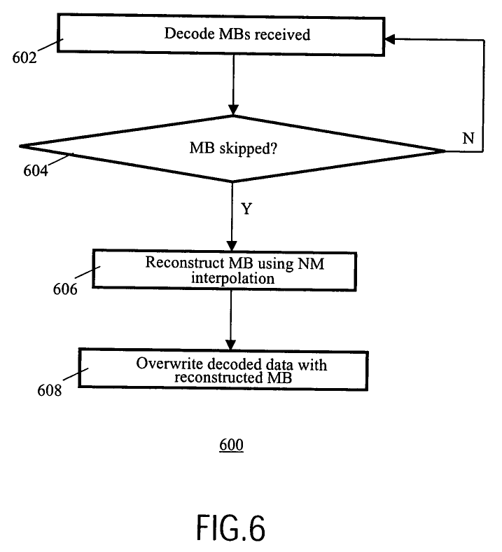

FIG. 6 is a flow diagram of a method of decoding in the invention. In a step 602, encoded MBs are decoded. In a step 604 it is detected whether an MB was skipped. If an MB was skipped, a motion-compensated interpolated MB is reconstructed in a step 606, and in a step 608 the data conventionally generated under the skipped-macroblock condition is overwritten with the newly reconstructed MB.

From the above discussion it is clear that other coding schemes may use the invention of skipping a segment of a frame at the encoder and reliably recreating the segment at the decoder using NM estimation or another motion-compensated interpolation algorithm.

Further, an electronic device with an encoder or with a decoder according to the invention is, for example, an apparatus with a data source functionality (e.g., transmitter, storage) or a receiving functionality, respectively; or an electronic circuit such as an IC or a board for use in such an apparatus.

Also, some of the functionalities discussed in the drawing can be implemented using hardware or software or a combination of both. For example, software MPEG-2 video encoders and -decoders are known. The motion-compensated interpolation carried out in component 220 and the evaluation carried out by component 222 can be performed in its entirety in software as well. As a result, the invention also relates to control software module for being added to a software MPEG encoder and/or a software MPEG decoder installed at a video transmitter or receiver.

Incorporated herein by reference:

U.S. Pat. No. 6,567,469 (attorney docket US 000022) issued to Bert Rackett for MOTION ESTIMATION ALGORITHM SUITABLE FOR H.261 VIDEO CONFERENCING APPLICATION. This patent relates to a method for identifying an optimum motion vector for a current block of pixels in a current picture in a process for performing motion estimation. The method is implemented by evaluating a plurality of motion vector candidates for the current block of pixels by, for each motion vector candidate, calculating an error value that is representative of the differences between the values of the pixels of the current block of pixels and the values of a corresponding number of pixels in a reference block of pixels. While evaluating each motion vector candidate, the error value is checked, preferably at several points, while calculating the error value, and the evaluation is aborted for that motion vector candidate upon determining that the error value for that motion vector candidate falls below a prescribed threshold value. The motion vector candidate that has the lowest calculated error value is selected as the optimum motion vector for the current block of pixels. The motion vector candidates are preferably evaluated in two distinct phases, including a first phase that includes evaluating a subset of the motion vector candidates that have an intrinsically high probability of being the optimum motion vector candidate, and a second phase that includes performing a spatial search within a prescribed search region of a reference picture in order to identify a different reference block of pixels within the prescribed search region for each respective motion vector candidate evaluation.

U.S. Pat. No. 6,385,245 (attorney docket PHN 16,529) issued to Gerard de Haan et al., for MOTION ESTIMATION AND MOTION-COMPENSATED INTERPOLATION. This patent relates to a method of estimating motion. In the method, at least two motion parameter sets are generated from input video data, a motion parameter set being a set of parameters describing motion in an image, by means of which motion parameter set motion vectors can be calculated. One motion parameter set indicates a zero velocity for all image parts in an image, and each motion parameter set has corresponding local match errors. Output motion data are determined from the input video data in dependence on the at least two motion parameter sets, wherein the importance of each motion parameter set in calculating the output motion data depends on the motion parameter sets' local match errors.

1. A method of encoding a video picture, the method comprising:
for a segment of the video picture determining if the segment can be reconstructed from at least another video picture based on motion-compensated interpolation applied to the other video picture;
if the segment cannot be reconstructed, encoding the segment; and
otherwise skipping the segment.

2. The method of claim 1, wherein the segment comprises a macroblock.

3. The method of claim 1, wherein the encoding comprises using a coding scheme compliant with one of ISO and ITU video compression standards.

4. The method of claim 3, wherein the coding scheme complies with MPEG-2 and wherein the determining comprises:
decoding an encoded B-picture;
generating a further picture using motion-compensated interpolation applied to the other video picture;
determining a difference per macroblock between the decoded B-picture and the further picture; and
evaluating the difference under control of a consistency measure of motion vectors associated with the further picture.

5. An electronic device comprising an encoder for encoding a video picture, wherein the encoder is configured to determine for a segment of the picture if the segment can be reconstructed from at least another video picture based on motion-compensated interpolation applied to the other video picture; and wherein the encoder encodes the segment if the segment cannot be reconstructed, and skips the segment otherwise.

6. The device of claim 5, wherein the segment comprises a macroblock.

7. The device of claim 5, wherein the encoder is configured to use a coding scheme compliant with one of ISO and ITU video compression standards.

8. The device of claim 7, wherein the coding scheme complies with MPEG-2 and wherein the encoder comprises:
a decoder for decoding an encoded B-picture;
a generator for generating a further picture using motion-compensated interpolation applied to the other video picture;
a comparator for determining a difference per macroblock between the decoded B-picture and the further picture; and
an evaluator for evaluating the difference under control of a consistency measure of motion vectors associated with the further picture.

9. A method of decoding an encoded video picture, the method comprising:
determining if a segment of the picture is missing; and
if the segment is missing, reconstructing the segment from motion-compensated interpolation applied to at least another video picture.

10. The method of claim 9, wherein the segment comprises a macroblock.

11. The method of claim 9, wherein the video picture is encoded using a coding scheme compliant with one of ISO and ITU video compression standards.

12. The method of claim 10, wherein:
decoding the picture comprises using an MPEG-2 skipped-macroblock condition; and
writing data, generated by the motion-compensated interpolation to reconstruct the macroblock, over further data generated under the skipped-macroblock condition.

13. An electronic device comprising a decoder for decoding an encoded video picture, the decoder being operative to reconstruct a missing segment of the video picture based on motion-compensated interpolation applied to at least another video picture.

14. The device of claim 13, wherein the missing segment comprises a macroblock.

15. The device of claim 13, configured to decode the picture encoded using a coding scheme compliant with one of ISO and ITU video compression standards.

16. The device of claim 14, configured to decode the picture using a skipped-macroblock condition; and operative to write data, generated by the motion-compensated interpolation to reconstruct the macroblock, over further data generated under the skipped-macroblock condition.

17. Control software for installing on an electronic device for decoding a video picture from which a segment is missing, the software being configured to reconstruct the segment based on motion compensated interpolation applied to at least another video picture.

18. Control software for installing on an electronic device for encoding a video picture, the software being configured to determine for a segment of the picture if the segment can be reconstructed from at least another video picture based on motion-compensated interpolation applied to the other video picture; and to control the encoding so as to have the segment encoded if the segment cannot be reconstructed, and to have the segment skipped otherwise.

19. Electronic video content information encoded such that at decoding at least one segment of at least one picture is to be reconstructed using motion-compensated interpolation performed on at least one other picture.

20. The method of claim 3, wherein the coding scheme complies with MPEG-2 and wherein the determining comprises:
generating a further picture using motion-compensated interpolation applied to the other video picture;
determining a difference per macroblock between the further picture and the video picture; and
evaluating the difference under control of a consistency measure of motion vectors associated with the further picture.

21. The device of claim 7, wherein the coding scheme complies with MPEG-2 and wherein the encoder comprises:
a generator for generating a further picture using motion-compensated interpolation applied to the other video picture;
a comparator for determining a difference per macroblock between the further picture and the video picture; and
an evaluator for evaluating the difference under control of a consistency measure of motion vectors associated with the further picture.
